(19) United States
(12) Patent Application Publication
(10) Pub. No.: US 2026/0247130 A1
(43) Pub. Date: Aug. 20, 2026

(54) LEADER ELECTION FOR MULTI-DEVICE OPERATIONS

(71) Applicant: Apple Inc., Cupertino, CA (US)

(72) Inventors: Siva Ganesh Movva, San Jose, CA (US); Michael C. Laster, Santa Clara, CA (US); Emmanuel Lalande, Montreal (CA); Neha Atri, Sunnyvale, CA (US)

(73) Assignee: Apple Inc., Cupertino, CA (US)

(21) Appl. No.: 19/543,611

(22) Filed: Feb. 18, 2026

Related U.S. Application Data
(60) Provisional application No. 63/760,059, filed on Feb. 18, 2025.

(51) Int. Cl. H04W 8/00; H04W 84/20

(52) U.S. Cl. CPC H04W 8/005; H04W 84/20

(57) ABSTRACT

Techniques may include detecting one or more identifiers of one or more electronic devices that are associated with a first electronic device. In addition, the techniques may include accessing a set of device properties corresponding to a set of electronic devices that includes the one or more electronic devices. The techniques may include accessing a subset of device properties of the set of device properties that correspond to the one or more electronic devices. Moreover, the techniques may include comparing the subset of device properties against one or more group criteria, where a device property may include at least one of a device type, a software version, a power capacity, a charging state, and an activity state. Also, the techniques may include designating the first electronic device as a group leader device of the one or more electronic devices. Further, the techniques may include performing a scheduled operation.

### CROSS-REFERENCES TO OTHER APPLICATIONS

This application claims the benefit of U.S. Provisional Application No. 63/760,059, for “LEADER ELECTION FOR MULTI-DEVICE OPERATIONS” filed on Feb. 18, 2025, which is herein incorporated by reference in its entirety for all purposes.

### BACKGROUND

Electronic devices may perform scheduled tasks such as sharing location data, reporting identifiers to help locate missing devices, and sharing photos. These tasks may be redundant, and, for example, a group of devices may each detect and report identifiers for all of the other group members. This redundancy can mean that the devices waste power and computing resources on unnecessary tasks. In addition, server resources are spent processing and storing duplicative information. Accordingly, improvements to performing scheduled tasks by a group of electronic devices are desirable.

### BRIEF SUMMARY

A group of electronic devices can negotiate and select a group leader that can perform these scheduled tasks on behalf of the group. A device in the group can retrieve properties for the other devices, and the properties can be used to select a group leader. These properties can include the device type, power capacity, charging state, and activity state. For example, the devices may select a group leader that is charging to preserve battery capacity across the group. Group membership can be dynamic, and the devices may select a different leader as the group composition or properties change.

Techniques may include detecting or receiving one or more identifiers of one or more electronic devices that are associated with a first electronic device. In addition, the techniques may include accessing a set of device properties corresponding to a set of electronic devices that includes the one or more electronic devices. The techniques may include accessing a subset of device properties of the set of device properties that correspond to the one or more electronic devices. Moreover, the techniques may include comparing the subset of device properties against one or more group criteria, where a device property may include at least one of a device type, a software version, a power capacity, a charging state, and an activity state. Also, the techniques may include designating the first electronic device as a group leader device of the one or more electronic devices or as a non-leader device of the group of electronic devices. Further, the techniques may include performing a scheduled operation or delaying a scheduled operation.

The techniques can be implemented as a method, a computer program product, a non-transitory computer readable medium, and a computing device comprising one or more memories and one or more processors in communication with the memories.

### BRIEF DESCRIPTION OF THE DRAWINGS

FIG. 1 is a simplified diagram showing groups of devices that are communicating with a server without leader election according to at least one embodiment.

FIG. 2 is a simplified diagram showing groups of devices that are communicating with a server with leader election according to at least one embodiment.

FIG. 3 is a simplified diagram showing a single group of devices that are communicating with a server with group election according to at least one embodiment.

FIG. 4 shows a simplified flow diagram of a process for triggering a leader election procedure according to at least one embodiment.

FIG. 5 shows a simplified flow diagram of a process for leader election and performing a scheduled operation according to at least one embodiment.

FIG. 6 shows a simplified flow diagram of a process for leader election and performing a scheduled operation according to at least one embodiment.

FIG. 7 shows a simplified flow diagram of a process for leader election and performing a scheduled operation according to at least one embodiment.

FIG. 8 is a block diagram of an example electronic device according to at least one embodiment.

FIG. 9 shows a diagram of an example computer system according to an embodiment of the present disclosure.

### DETAILED DESCRIPTION

A group of electronic devices can negotiate and select a group leader that can perform these scheduled tasks on behalf of the group. A device in the group can retrieve properties for the other devices, and the properties can be used to select a group leader. These properties can include the device type, power capacity, charging state, and activity state. For example, the devices may select a group leader that is charging to preserve battery capacity across the group. Group membership can be dynamic, and the devices may select a different leader as the group composition or properties change.

A group of devices may perform scheduled operations, and for example, the scheduled operations can include location reporting. These devices may all be associated devices because they are the personal devices of a particular user, and a user account can be authenticated on each device. The scheduled operation can include communication with a server, and, for example, the locations for each device can be recorded by the server. The user can use the location reporting to track lost devices, and a user may wish to have regular updates for each device's location. However, the devices may be at the same location, and it can be redundant to have each device separately report its location or perform another scheduled operation. Accordingly, the devices may elect a group leader that performs the scheduled operation on behalf of the other devices.

A user's devices may change groups dynamically. For example, a user may use her laptop, smartphone, and smartwatch while working at home, but she may only bring her smartwatch and smartphone to the gym. A group can be a group of devices at a particular location, and a group leader can be elected at each change in group membership. The group leader election procedure can be performed at each electronic device in a group, and, in addition or alternatively, the group leader election may be performed at a server. A device may determine group membership by detecting devices by monitoring advertising messages from proximate devices. For example, a group leader device may use the advertising messages to report the locations of all detected devices as part of a scheduled operation. If a new device is detected, or a previously detected device is missing, a new round of the group leader election procedure can be performed.

The group election procedure can provide a technical improvement by improving the functioning of electronic devices in a group. The election of a group leader can allow a non-leader device to conserve power and computing resources by delaying or halting a scheduled operation. This can reduce the amount of processing that each device performs to gather information to perform the scheduled operation, and the amount of information that is transmitted over a network. The non-leader devices may also conserve battery power as a result of delaying or halting the scheduled operations.

The functioning of a server can be improved by the group election procedure. The server uses computing resources to ingest and process the scheduled operations, and the election of a group leader can result in a substantial decrease in the number of scheduled operations that are performed with a group of devices. With an elected group leader, the server can perform the scheduled operation while using a reduced amount of processing power, memory, and electrical power. Therefore group election can provide a technical improvement to the functioning of a server.

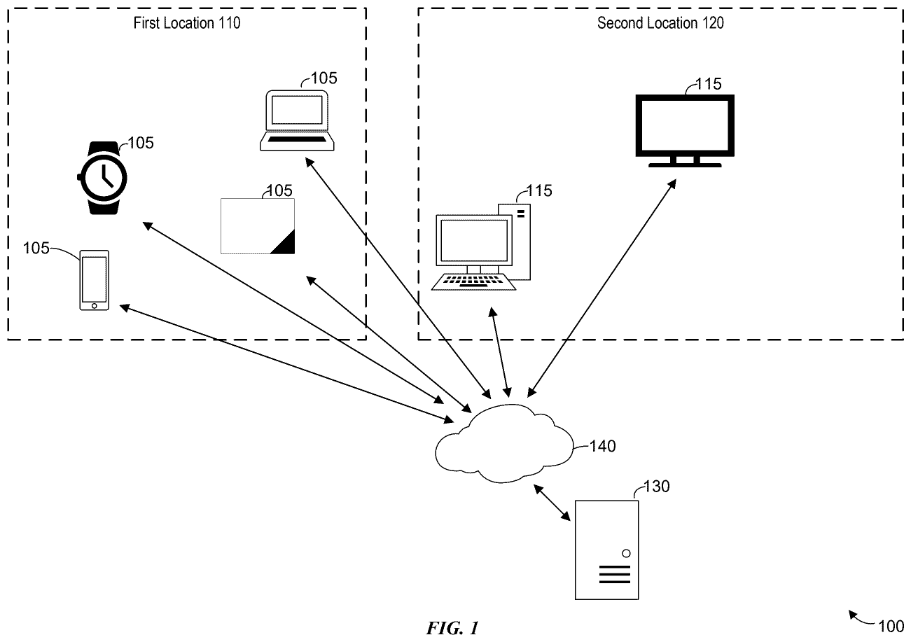

FIG. 1 is a simplified diagram 100 showing groups of devices that are communicating with a server without leader election according to at least one embodiment. The diagram 100 shows a first group of devices 105 at a first location 110 and a second group of devices 115 at a second location 120. The first group of devices 105 and the second group of devices 115 are associated devices, and, for example, the devices may all share a common user account that is authenticated on each device in the groups of devices. The first group of devices 105 and the second group of devices 115 may perform one or more scheduled operations. The devices in both the first group of devices 105 and the second group of devices 115 can be electronic devices (e.g., device 800).

The scheduled operations can include communication with a server 130 via a network 140. The scheduled operations can be performed by each of the group of devices and the scheduled operations can include reporting location information for each of the devices. Location information can include a street address, a zip code, coordinates (e.g., global positioning service (GPS) coordinates, an internet protocol address, and a device identifier for an internet access point (e.g., a media access control (MAC) address). The scheduled operations may include photo sharing or other operation to synchronize information across devices within the first group of devices 105, the second group of devices 115, or both the first group of devices 105 and the second group of devices 115. The scheduled operations may be performed at regular intervals, in response to an event, or both.

The server 130 can ingest information that is received from each device of the first group of devices 105 and the second group of devices 115 in response to the scheduled operations. Ingesting the received information by the server 130 can include storing the received information in memory, correcting errors in the received information, retrieving stored information that corresponds to the received information from a database, comparing the received information and the stored information, sharing the received information with one or more of the devices in the first group of devices 105 and the second group of deices 115, and adding the received information to the database. Ingesting the received information may consume computing resources for the server 130, and these resources can include processing power, memory, and storage capacity.

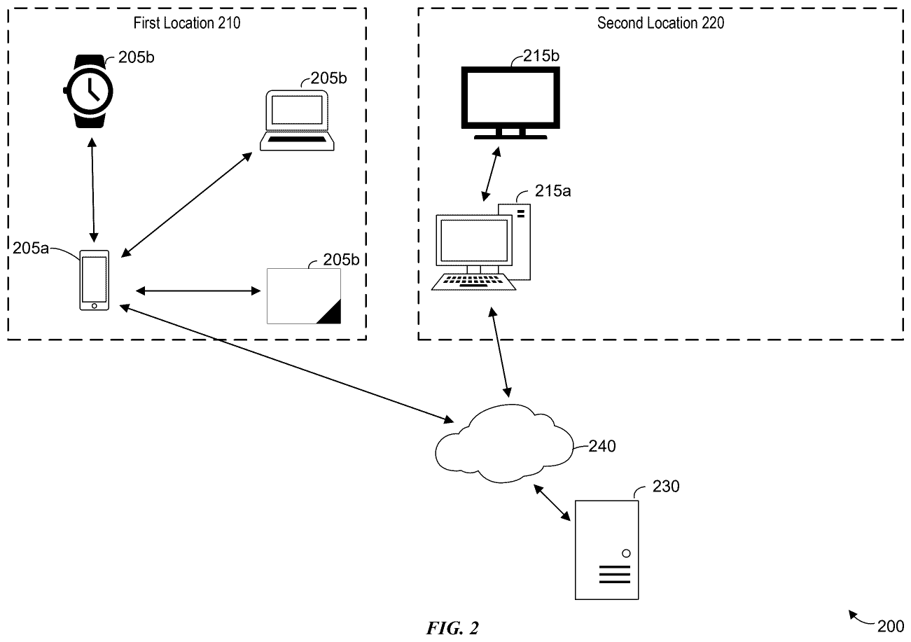

FIG. 2 is a simplified diagram 200 showing groups of devices that are communicating with a server with leader election according to at least one embodiment. Leader election can be a process where a reduced number of devices is selected from a group of devices that each perform a scheduled operation, and the reduced number of devices perform the scheduled operation on behalf of all devices in the group.

A group leader (e.g., a group leader device) can be separately elected at each device within each group of devices. The group leader election procedure can include comparing device properties against one or more election criteria. These election criteria can be ranked configurations of the device properties, and the properties for each device in the groups can be compared against the election criteria to determine a ranking for each device. The highest ranked device can be selected as the group leader. For example, a first desktop computer with the most recent software version of an operating system may be ranked higher than a second desktop computer with an older software version, and these two devices may both be ranked higher than a smartwatch. Therefore, the first desktop computer, the second desktop computer, and the smartwatch may all determine that the first desktop computer should be designated as the group leader. This group election procedure can be performed separately at each device and at a server. Because each device includes the same logic for performing the group leader election, all devices within proximity to each other are likely to arrive at the same conclusion, e.g., which device in the group will be the leader and which device(s) will not be. In some examples, this result may be achieved without the devices performed without the devices having to explicitly communicate with each other about their respective leader state.

The reduced number of devices can be a single device (e.g., a group leader). As an example, the scheduled operation can include reporting device locations, and the group leader 205a can transmit information identifying that the first group of devices 205a-205b are at the first location 210 to the server 230 via the network 240. Group leader 215a can transmit information identifying that the second group of devices 205a-205b are at the second location 210 to the server 230 via the network 240.

The group leader may retrieve information from the remaining devices in a group in order to perform the scheduled operation. For example, group leader 205a may monitor advertising messages from the non-leader devices 205b to determine all of the devices in the first group 205a-205b and the group leader 205a may transmit a location for each of the devices in the first location 210. In some embodiments, the group leader 205a may transmit the group leader location, and the server 230 can assign the location of the group leader 205a to all of the devices in the first group 205a-205b.

In some embodiments, a group of devices can include devices that are at separate locations. These devices may be communicating over a network such as a cellular network, a local access network, a wide area network, or a mesh network. In such embodiments, the devices may provide information about the scheduled activity to a group leader via the network, and the group leader can use this information to perform the scheduled activity.

Electing a group leader can improve the functioning of the devices in the first group of devices 205a-205b, the second group of devices 210a-210b, and the server 230. The non-leader devices 205b and non-leader device 215b, may delay performing scheduled operations and this can mean that the non-leader devices conserve battery power because the devices do not need to transmit information to the server 230 in accordance with the scheduled operations. For example, the non-leader devices 205b and non-leader device 215b may enter a low power mode by placing one or more of the wireless communication antenna and circuitry and the application processor in a reduced power state. The functioning of the server 230 can be improved because the server does not need to use computing resources to ingest received information from the non-leader devices 205b and non-leader device 215b.

In some embodiments, a non-leader device may perform the scheduled operation in response to an event. For example, the non-leader device may detect a signal that is from an electronic device that is in a lost mode. The non-leader device may perform the scheduled operation to report information about the lost electronic device to the server 230, even if a leader device is available.

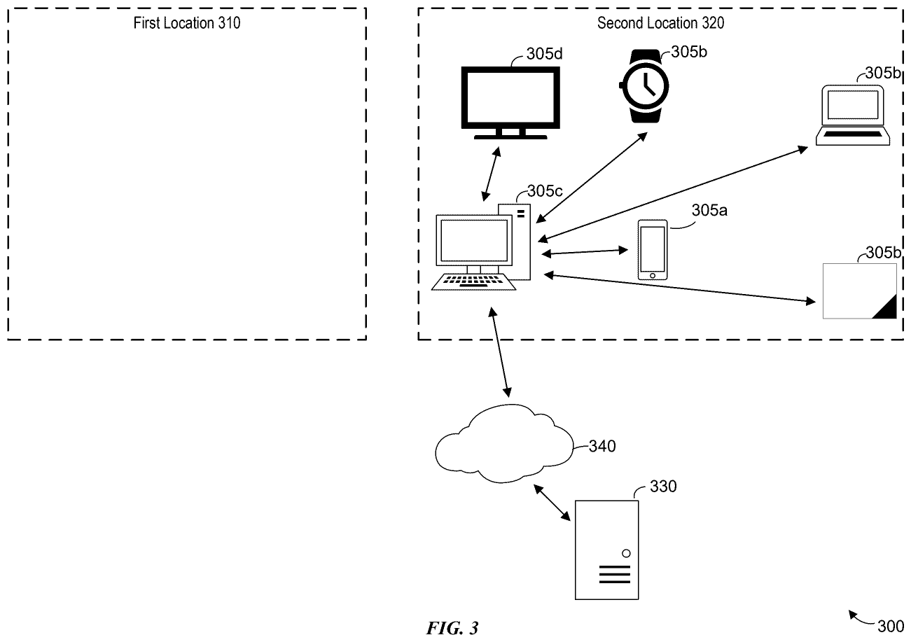

FIG. 3 is a simplified diagram 300 showing a single group of devices that are communicating with a server with group election according to at least one embodiment. The server can be any type of computing device, and the group of devices 305a-305d can include any type of computing device such as a smartphone, a smartwatch, a desktop computer, a laptop computer, a tablet computer, a smart television, a streaming device, a smart appliance, a beacon device (e.g., airtag), or any other suitable device capable of network communication.

As shown in diagram 300, the first group of devices 305a-305b that were previously shown at the first location 310 (e.g., in diagrams 100 and 200) have moved to the second location 320. The first group of devices 305a-305b may have moved with a human user from work (e.g., first location 310) to the user's home (e.g., second location 320). The user can be a human user or a digital avatar of the human user (e.g., a user account).

The arrival of the first group of devices 305a-305b at the second location 320 may prompt a leader election procedure to determine a leader for the combined group of devices 305a-305d. Previously, the device 305a was the leader of the first group of devices 305a-305b, and device 305c was the leader of the second group of devices 305c-305d. The combined group of devices 305a-305d may only require a single leader device, and the leader election procedure can select a single leader for the combined group 305a-305d.

The leader election procedure can be performed by some or all of the devices in the combined group of devices 305a-305d. In addition or alternatively, the leader election procedure may be performed by the server 330. The leader election procedure may be performed at regular intervals (e.g., hourly) by any combination of any number of the devices in the combined group of devices 305a-305d and the server 330. The leader election procedure may be performed in response to an event, and, for example, the procedure may be performed in response to determining a change to the number of devices at a location, when a condition by which the leader was elected changes (e.g., a laptop is unplugged from power), and according to any other suitable event. For example, any of the devices in the combined group of devices 305a-305d may broadcast advertising messages, and the devices may perform the leader election procedure if an advertising message is received from a device that was not present when the last leader election procedure was performed.

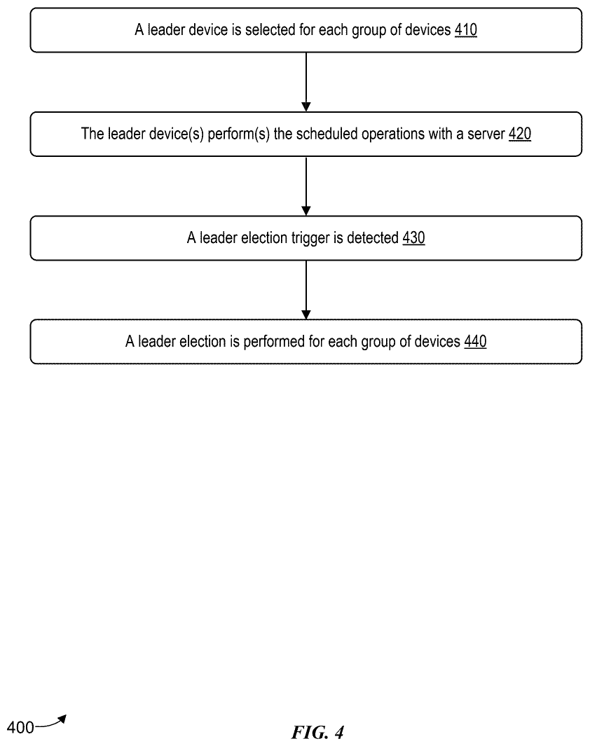

FIG. 4 shows a simplified flow diagram 400 of a process for triggering a leader election procedure according to at least one embodiment. This process is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes.

At block 410, a leader device may be selected from the group of devices at a location. The initial leader may be a device that initiated a scheduled operation. The group of devices at a location may not perform scheduled operations until an initial leader has been elected. If devices are at multiple locations, a leader can be selected for each group of devices at each location.

At block 420, the leader device for each group of devices may perform the scheduled operation with a server. The server may mark the device as the leader for the group of devices in response to the initiated operation. The leader device may update a local state to indicate that the device is a leader, and, in some embodiments, a device may only perform a scheduled operation if the device state indicates that the device is a leader. In some embodiments, the scheduled operations can include location sharing where each device that is designated as a leader reports a location to a server. The devices may identify proximate devices (e.g., via advertising messages or network discovery) and the device may identify the proximate devices as a scheduled operation (e.g., a scheduled activity).

At block 430, a leader election trigger is detected. The leader election trigger can be a periodic trigger, and, for example, the leader election trigger may occur at regular intervals (e.g., every 10 minutes, every 12 hours, every 24 hours, etc.). The leader election trigger may be an event-based trigger in some embodiments. For example, a server may send a push message that acts as a leader election trigger if the scheduled operation data for one of the devices is stale (e.g., the data has not been updated within a time threshold). The leader election trigger can be generated by a device in the group of devices. For example, a device at a location may detect a leader election trigger if a new device is detected at the location. The leader election may be triggered by a determination that a current group leader has been the leader for a threshold amount of time, or the current state of the group leader (e.g., a change in battery capacity) means that the current group leader is no longer suitable as the group leader. The threshold amount of time can be 5 seconds, 30 seconds, 1 minute, 2 minutes, 5 minutes, 15 minutes, 30 minutes, 1 hour, 2 hours, 3 hours, 6 hours, 12 hours, 24 hours, 2 days, and a week.

At block 440, a leader election is performed. The leader election can be performed in response to an election trigger. The leader election may be performed at a server, at the group of devices, or at both the server and the group of devices. The server may provide a message (e.g., a push message) to devices in the group of devices, and the message may prompt the devices to perform a leader election procedure. This message may be sent to all devices or only a subset of devices in a group (e.g., only the leader). The devices may report whether they are the leader or a non-leader device to the server after the leader election procedure has been performed. The devices may include device properties with the request, and the server can perform the leader election procedure to determine a leader device. The server can report to each device whether the device is a leader device or non-leader device after performing the procedure, and the devices may update their leader status to the status received from the server.

To perform leader election at a device, the device may detect proximate devices (e.g., devices at a location; devices within communication range of the device). Each device in a group may separately perform a group leader election procedure. The device may detect the proximate devices through advertising messages that are transmitted by each device. The advertising messages can include information that can be used to determine a device identifier, and device properties. The device properties can include any combination of any number of a device type, a software version, a power capacity, a charging state, and an activity state.

The device can add each detected device to a group of devices, and the device properties can be used to elect a leader for the group. The activity state can be used to determine if a network connection type for the devices, and a leader may be selected from devices based on whether the device is connected to a network and a type of network connection. For example, a device that is connected to a wireless access point may be elected as a leader over an identical device that is connected to a cellular network. The device type can be used to elect a leader. The device type may indicate whether a device is a laptop computer, a desktop computer, a smartphone, a tablet computer, a streaming device, a smart appliance, a smart speaker, a smart home device (e.g., a device for coordinating automations across smart devices at a location), a smartwatch, or a head mounted display device. There may be a preference order for electing a group leader from the device types, and, for example, a desktop computer may be preferred over a smartwatch.

The device types may group devices into wired devices, mobile devices, and wearable devices. Wired devices (e.g., devices that receive power though an outlet) may be preferred over battery powered devices (e.g., mobile devices and wearable devices). For example, a desktop computer, a streaming device, or a smart appliance (e.g., wired devices) may be preferred over a laptop computer or a smartphone (mobile devices). Wearable devices, such as a smartwatch or head mounted display device, may be a separate category from mobile devices and mobile devices may be preferred over wearable devices. The device type may indicate a specific version or model of the device (e.g., smartwatch 1.0 or smartwatch 2.0), and model/version numbers that correspond to more recently released devices may be preferred over older devices.

The device properties can include a battery capacity and/or a charging state for wearable devices and mobile devices. The charging state may indicate whether the device is receiving power from an external source, and a charging mobile device may be prioritized over a mobile device that is not charging. A charging wearable device may be prioritized over a wearable device that is not charging, but any available mobile device may be prioritized over any wearable device regardless of the charging state. Battery capacity can be used to distinguish between mobile devices, and a mobile device with a higher battery capacity (e.g., remaining charge) may be prioritized over a mobile device with a lower battery capacity. A mobile device may be prioritized over a wearable device regardless of the battery capacity of each device. However, a wearable device with a higher battery capacity (e.g., remaining charge) may be prioritized over a wearable device with a lower battery capacity. The device properties can include an amount of time that the device has been a group leader over a preceding time period. A device that has been group leader for a larger proportion of this period of time may be less likely to be selected as a group leader. The time period can be 5 seconds, 30 seconds, 1 minute, 2 minutes, 5 minutes, 15 minutes, 30 minutes, 1 hour, 2 hours, 3 hours, 6 hours, 12 hours, 24 hours, 2 days, and a week.

In some embodiments, the software version can be used to elect a group leader. The software version may refer to an operating system version, and a device with a more recent software version may be preferred as a leader over an identical device with an older software version. Each device should separately perform the procedure to elect a group leader and the devices should reach the same conclusion. Each device can record whether it is a group leader, and only a device that is marked as a group leader may perform the scheduled operation. In some embodiments, the non-leader devices may perform the scheduled operation at a lower rate than the leader device. In some embodiments, the non-leader devices may enter a low power mode.

To perform leader election at a server, the server may prompt (e.g., via a push message) the devices to provide a location and/or one or more device properties. The device properties can include any combination of any number of a device type, a software version, a power capacity, a charging state, and an operation state as described above. The location can be used to determine groups of devices at each location and the device properties can be used to elect a leader. The device properties can include a serial number for each device, and the serial number can be used to elect a leader if the election procedure indicates that both devices are equally good candidates (e.g., the highest or lowest serial number is elected leader). In some embodiments, a leader may lose power or become otherwise unable to perform a scheduled operation. If the device comes back online, and a separate leader has been elected in the intervening time, the server may instruct the previously offline device to change the device's state from leader to non-leader in response to the scheduled operation.

The server and each of the electronic devices may perform a leader election procedure to determine groups and group leaders. Each group should have one group leader, and each electronic device that is performing the group leader election procedure should independently identify the same group leader. The server may separately determine a group leader using the group leader election procedure. The electronic devices may provide a leader check request to the server, and the server can respond by indicating whether the requesting device is a group leader. The electronic devices can update their state to indicate whether each device is a group leader device or a non-leader device. This leader check may help to correct circumstances where two group leaders are unintentionally elected for a group.

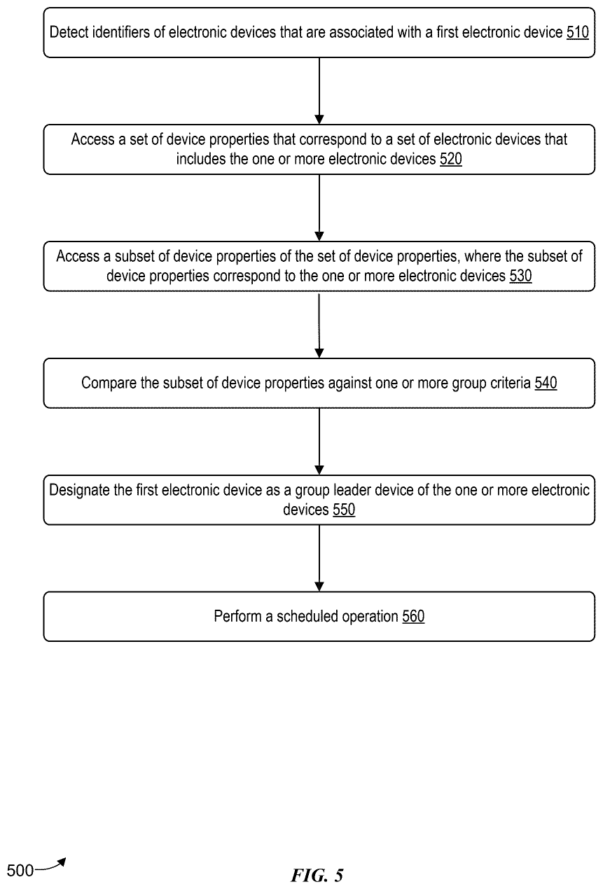

FIG. 5 is a simplified flow diagram of a process for leader election and performing a scheduled operation according to at least one embodiment. According to an example, one or more process blocks of FIG. 5 may be performed by mobile device 800 and/or a computer system 900. Process 500 can be implemented as a method, a computer program product, a non-transitory computer readable medium, and a computing device comprising one or more memories and one or more processors in communication with the memories.

At block 510, process 500 may include detecting, by a first electronic device, one or more identifiers of one or more electronic devices that are associated with the first electronic device. For example, the one more identifiers may include information that is associated with a user account such as an account number, a username, an email address, and a device identifier. The identifier can be included in a header of an advertising message (e.g., a Bluetooth Low Energy (BLE) advertising message. The one or more electronic devices may be associated with the first electronic device by their association with the user account or a group of related accounts. The one or more electronic devices may be associated if they are part of an information sharing agreement (e.g., photo sharing) between the devices. Detecting the one or more identifiers may include receiving an advertising message from the one or more electronic devices and extracting the identifier from the header or payload of the advertising message.

At block 520, process 500 may include accessing, by the first electronic device, a set of device properties corresponding to a set of electronic devices that includes the one or more electronic devices. The set of electronic devices can include all devices that are associated with the first electronic device, and the subset of electronic devices may include a group of the associated electronic devices that are detected by the first electronic device at 510. For example, the subset of electronic devices can include some or all of the associated electronic devices that are collocated at a particular location.

At block 530 process 500 may include accessing, by the first electronic device, a subset of device properties of the set of device properties, where the subset of device properties correspond to the one or more electronic devices. The subset of device properties can include the properties for the one or more electronic devices that were detected by the first electronic device at 510.

At block 540, process 500 may include comparing, by the first electronic device, the subset of device properties against one or more group criteria, where a device property may include at least one of a device type, a software version, a power capacity, a charging state, and an activity state. The device properties may include a signal strength of advertising messages (e.g., Bluetooth advertising messages) that are received from each device in the group. The group criteria can include ranked sets of configurations for the device properties. The device properties for each electronic device from 510 may be compared against the group criteria and an electronic device may be designated as a group leader if it matches the highest ranked group criteria. The activity state can indicate whether a device is online and connected to a network (e.g., a cellular network; the Internet), or whether the device is offline and not connected to a network. The activity state may indicate a signal strength for each network connection (e.g., a Bluetooth received signal strength indicator (RSSI)). The activity state may include information about the device's movement activity over a preceding time period. For example, the activity state can indicate a number of location changes for the device, a number of separate access point connection events for the device, a number of processor wake events, a screen wake duration for the device (e.g., a length of time that the device has been active during the time period), and an amount of input that the device has received over the time period. The time period can be 5 seconds, 30 seconds, 1 minute, 2 minutes, 5 minutes, 15 minutes, 30 minutes, 1 hour, 2 hours, 3 hours, 6 hours, 12 hours, 24 hours, 2 days, and a week. The activity state for a device can include a prediction of a next processor wake time, or a next screen wake time for the device.

At block 550, process 500 may include designating, by the first electronic device, the first electronic device as a group leader device of the one or more electronic devices based at least in part on the comparing. The first electronic device can designate that the first electronic device is the group leader device by updating the device state for the first electronic device to indicate that the device is a group leader.

At block 560, process 500 may include performing, by the first electronic device, a scheduled operation. Performing a scheduled operation may include sending a device location to a server. The device location may identify a street address, an internet protocol address, a device identifier for an access point (e.g., a MAC address), a set of coordinates (e.g., GPS coordinates), or any other information that identifies the device location. The first electronic device may perform the scheduled operation by monitoring for device identifiers and reporting the device identifiers to the server.

Process 500 may include additional implementations, such as any single implementation or any combination of implementations described below and/or in connection with one or more other processes described elsewhere herein. In a first implementation, accessing the subset of device properties may include: generating, by the first electronic device, a set of generated keys by providing the one or more identifiers as input to a key algorithm; comparing, by the first electronic device, the set of generated keys to a stored set of keys to identify a subset of keys that correspond a subset of electronic devices that are associated with the first electronic device, where the subset of keys are present in both the set of generated keys and the stored set of keys; and accessing, by the first electronic device, the subset of device properties using the subset of keys.

In a second implementation, alone or in combination with the first implementation, the one or more identifiers are detected by: receiving, by the first electronic device, a plurality of advertising messages from a plurality of electronic devices, where the plurality of advertising messages are transmitted using a short-range communication protocol; and identifying, by the first electronic device, the one or more identifiers from the plurality of advertising messages.

In a third implementation, alone or in combination with the first and second implementation, the short-range communication protocol is one of a Bluetooth communication protocol, a Bluetooth low energy communication protocol, or a WiFi communication protocol.

It should be noted that while FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

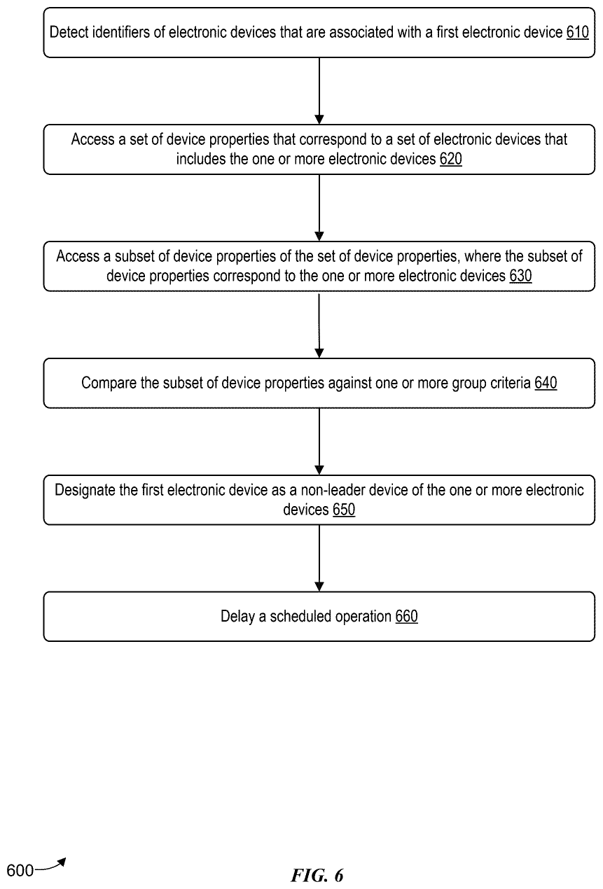

FIG. 6 simplified flow diagram of a process for leader election and performing a scheduled operation according to at least one embodiment.. In some implementations, one or more process blocks of FIG. 6 may be performed by a mobile device 800 and/or a computer system 900. Process 600 can be implemented as a method, a computer program product, a non-transitory computer readable medium, and a computing device comprising one or more memories and one or more processors in communication with the memories.

At block 610, process 600 may include detecting, by a first electronic device, one or more identifiers of one or more electronic devices that are associated with the first electronic device. For example, the one more identifiers may include information that is associated with a user account such as an account number, a username, an email address, and a device identifier. The identifier can be included in a header of an advertising message (e.g., a Bluetooth Low Energy (BLE) advertising message. The one or more electronic devices may be associated with the first electronic device by their association with the user account or a group of related accounts. The one or more electronic devices may be associated if they are part of an information sharing agreement (e.g., photo sharing) between the devices. Detecting the one or more identifiers may include receiving an advertising message from the one or more electronic devices and extracting the identifier from the header or payload of the advertising message.

At block 620, process 600 may include accessing, by the first electronic device, a set of device properties corresponding to a set of electronic devices that includes the one or more electronic devices. The set of electronic devices can include all devices that are associated with the first electronic device, and the subset of electronic devices may include a group of the associated electronic devices that are detected by the first electronic device at 610. For example, the subset of electronic devices can include some or all of the associated electronic devices that are collocated at a particular location.

At block 630, process 600 may include accessing, by the first electronic device, a subset of device properties of the set of device properties, where the subset of device properties correspond to the one or more electronic devices. The subset of device properties can include the properties for the one or more electronic devices that were detected by the first electronic device at 610.

At block 640, process 600 may include comparing, by the first electronic device, the subset of device properties against one or more group criteria, where a device property may include at least one of a device type, a software version, a power capacity, a charging state, and an activity state. The group criteria can include ranked sets of configurations for the device properties. The device properties for each electronic device from 610 may be compared against the group criteria and an electronic device may be designated as a group leader if it matches the highest ranked group criteria.

At block 650, process 600 may include designating, by the first electronic device, the first electronic device as a non-leader device of the one or more electronic devices based at least in part on the comparing. The first electronic device can designate that the first electronic device is a non-leader device by updating the device state for the first electronic device to indicate that the device is not the group leader.

At block 660, process 600 may include delaying, by the first electronic device, a scheduled operation. The first electronic device may perform the scheduled operation at a lower cadence in some embodiments, and the first electronic device may perform the scheduled operation after a delay. The first electronic device may enter a low power mode in response to the designation that the first electronic device is not a leader device.

Process 600 may include additional implementations, such as any single implementation or any combination of implementations described below and/or in connection with one or more other processes described elsewhere herein. A first implementation, process 600 further includes receiving, by the first electronic device and after a delay, a push notification from a server; and performing the scheduled operation.

In a second implementation, alone or in combination with the first implementation, accessing the subset of device properties may include: generating, by the first electronic device, a set of generated keys by providing the one or more identifiers as input to a key algorithm; comparing, by the first electronic device, the set of generated keys to a stored set of keys to identify a subset of keys that correspond a subset of electronic devices that are associated with the first electronic device, where the subset of keys are present in both the set of generated keys and the stored set of keys; and accessing, by the first electronic device, the subset of device properties using the subset of keys.

In a third implementation, alone or in combination with the first and second implementation, the one or more identifiers are detected by: receiving, by the first electronic device, a plurality of advertising messages from a plurality of electronic devices, where the plurality of advertising messages are transmitted using a short-range communication protocol; and identifying, by the first electronic device, the one or more identifiers from the plurality of advertising messages.

In a fourth implementation, alone or in combination with one or more of the first through third implementations, the short-range communication protocol is one of a Bluetooth communication protocol, a Bluetooth low energy communication protocol, or a WiFi communication protocol.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

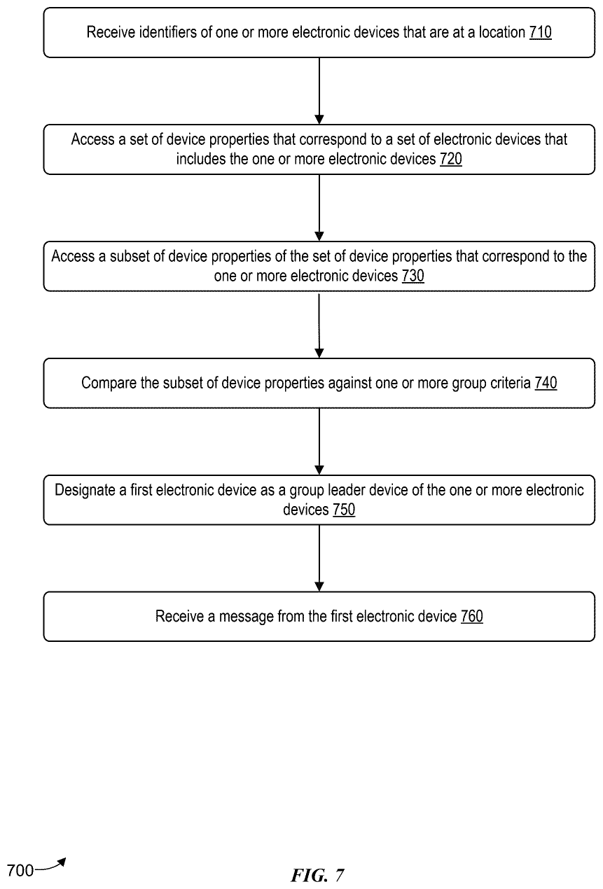

FIG. 7 is simplified flow diagram of a process for leader election and performing a scheduled operation according to at least one embodiment.. In some implementations, one or more process blocks of FIG. 7 may be performed by an electronic device 800 and/or a computer system 900. Process 700 can be implemented as a method, a computer program product, a non-transitory computer readable medium, and a computing device comprising one or more memories and one or more processors in communication with the memories.

At block 710, process 700 may include receiving, by a computing device, one or more identifiers of one or more electronic devices of a set of electronic devices, where the one or more electronic devices are at a location. For example, the one more identifiers may include information that is associated with a user account such as an account number, a username, an email address, and a device identifier. The identifier can be included in a header of an advertising message (e.g., a Bluetooth Low Energy (BLE) advertising message and the message may be detected by an electronic device that transmits the identifiers to the computing device. The one or more electronic devices may be associated by their association with the user account or a group of related accounts. The one or more electronic devices may be associated if they are part of an information sharing agreement (e.g., photo sharing) between the devices.

At block 720, process 700 may include accessing, by the computing device, a set of device properties corresponding to a set of electronic devices that includes the one or more electronic devices at the location. For example, the subset of electronic devices can include some or all of the associated electronic devices that are collocated at a particular location, and the set of electronic devices can include all electronic devices that are associated with a particular user account or group of accounts.

At block 730, process 700 may include accessing, by the computing device, a subset of device properties that correspond to the one or more electronic devices at the location.

At block 740, process 700 may include comparing, by the computing device, the subset of device properties against one or more group criteria, where a device property may include at least one of a device type, a software version, a power capacity, a charging state, and an activity state. The group criteria can include ranked sets of configurations for the device properties. The device properties for each electronic device from 710 may be compared against the group criteria and an electronic device may be designated as a group leader if it matches the highest ranked group criteria.

At block 750, process 700 may include designating, by the computing device, a first electronic device of the one or more electronic devices as a group leader device of the one or more electronic devices based at least in part on the comparing. The computing device may send a message to the first electronic device, and the message can indicate that the first electronic device is a group leader. In some embodiments, the computing device may receive a confirmation message from the first electronic device, and, if the confirmation message is not received, the computing device can identify a second ranked candidate for group leader and a message can be sent to the second ranked candidate (e.g., to indicate that the second ranked candidate is the group leader). In some embodiments, messages can be sent to the remaining electronic devices of the one or more electronic devices, and the messages can indicate that the remaining electronic devices are not group leader devices.

At block 760, process 700 may include receiving a message from the first electronic device at the computing device. The message can be sent by the first electronic deice in accordance with a scheduled operation (block 760). The computing device may initiate a new group leader election procedure if the message is not received from the first electronic device within a threshold amount of time of an anticipated time for the scheduled operation.

Process 700 may include additional implementations, such as any single implementation or any combination of implementations described below and/or in connection with one or more other processes described elsewhere herein. In a first implementation, designating the first electronic device as the group leader device may include: transmitting, by the computing device, information identifying the first electronic device as the group leader device to the one or more electronic devices.

In a second implementation, alone or in combination with the first implementation, designating the first electronic device as the group leader device may include: transmitting, by the computing device, information identifying the first electronic device as the group leader device to the first electronic device.

In a third implementation, alone or in combination with the first and second implementation, receiving the one or more identifiers may include: transmitting, by the computing device, a push message to the set of electronic devices; receiving, by the computing device, a corresponding identifier, a corresponding device property, and a corresponding location from each electronic device in the set of electronic devices; and grouping, by the computing device, the set of electronic devices based at least in part on the corresponding location for each electronic device.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

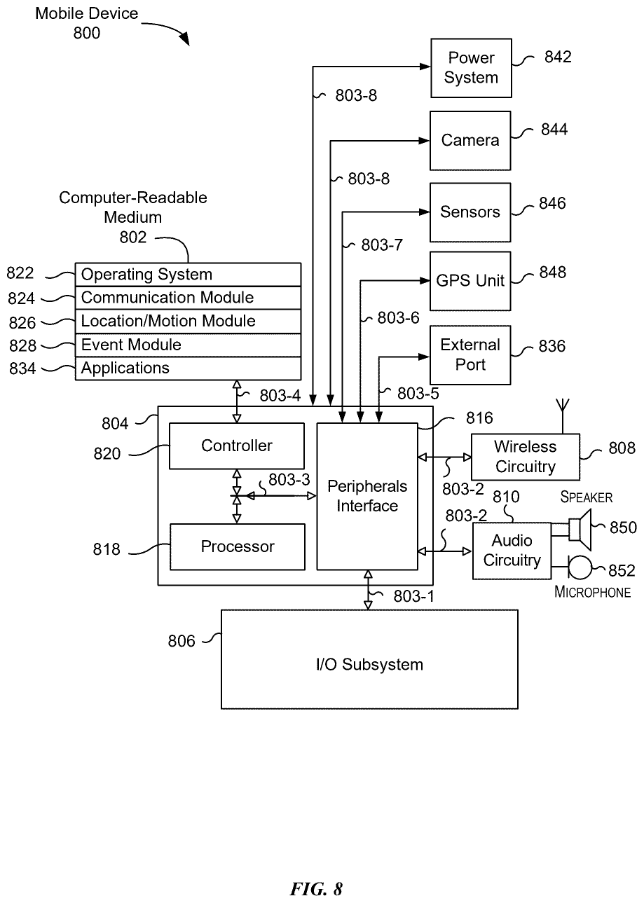

FIG. 8 is a block diagram of an example electronic device 800 according to at least one embodiment. Device 800 generally includes computer-readable medium 802, a processing system 804, an Input/Output (I/O) subsystem 806, wireless circuitry 808, and audio circuitry 810 including speaker 812 and microphone 814. These components may be coupled by one or more communication buses or signal lines 803. Device 800 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 8 is only one example of an architecture for device 800, and that device 800 can have more or fewer components than shown, or a different configuration of components. The various components shown in FIG. 8 can be implemented in hardware, software, or a combination of both hardware and software, including one or more signal processing and/or application specific integrated circuits.

Wireless circuitry 808 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 808 can use various protocols, e.g., as described herein. In various embodiments, wireless circuitry 808 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 808 is coupled to processing system 804 via peripherals interface 816. Peripherals interface 816 can include conventional components for establishing and maintaining communication between peripherals and processing system 804. Voice and data information received by wireless circuitry 808 (e.g., in speech recognition or voice command applications) is sent to one or more processors 818 via peripherals interface 816. One or more processors 818 are configurable to process various data formats for one or more application programs 834 stored on medium 802.

Peripherals interface 816 couple the input and output peripherals of device 800 to the one or more processors 818 and computer-readable medium 802. One or more processors 818 communicate with computer-readable medium 802 via a controller 820. Computer-readable medium 802 can be any device or medium that can store code and/or data for use by one or more processors 818. Computer-readable medium 802 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 816, one or more processors 818, and controller 820 can be implemented on a single chip, such as processing system 804. In some other embodiments, they can be implemented on separate chips.

Processor(s) 818 can include hardware and/or software elements that perform one or more processing functions, such as mathematical operations, logical operations, data manipulation operations, data transfer operations, controlling the reception of user input, controlling output of information to users, or the like. Processor(s) 818 can be embodied as one or more hardware processors, microprocessors, microcontrollers, field programmable gate arrays (FPGAs), application-specified integrated circuits (ASICs), or the like.

Device 800 also includes a power system 842 for powering the various hardware components. Power system 842 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 800 includes a camera 844. In some embodiments, device 800 includes sensors 846. Sensors can include accelerometers, compass, gyrometer, pressure sensors, audio sensors, light sensors, barometers, and the like. Sensors 846 can be used to sense location aspects, such as auditory or light signatures of a location.

In some embodiments, device 800 can include a GPS receiver, sometimes referred to as a GPS unit 848. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 818 run various software components stored in medium 802 to perform various functions for device 800. In some embodiments, the software components include an operating system 822, a communication module 824 (or set of instructions), a location module 826 (or set of instructions), a ranging module 828 that is used as part of ranging operation described herein, and other application programs 834 (or set of instructions).

Operating system 822 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 824 facilitates communication with other devices over one or more external ports 836 or via wireless circuitry 808 and includes various software components for handling data received from wireless circuitry 808 and/or external port 836. External port 836 (e.g., universal serial bus (USB), FireWire, Lightning connector, 80-pin connector, etc.) is adapted for coupling directly to other devices or indirectly over a network (e.g., the Internet, wireless local area network (LAN), etc.).

Location/motion module 826 can assist in determining the current position (e.g., coordinates or other geographic location identifiers) and motion of device 800. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 826 receives data from GPS unit 848 and analyzes the signals to determine the current position of the mobile device. In some embodiments, location/motion module 826 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 808 and is passed to location/motion module 826. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 800 based on the position coordinates of the corresponding transmitters. Regardless of the specific location technology used, location/motion module 826 receives information from which a location fix can be derived, interprets that information, and returns location information, such as geographic coordinates, latitude/longitude, or other location fix data

Ranging module 828 can send/receive ranging messages to/from an antenna, e.g., connected to wireless circuitry 808. The messages can be used for various purposes, e.g., to identify a sending antenna of a device, determine timestamps of messages to determine a distance of mobile device 800 from another device. Ranging module 828 can exist on various processors of the device, e.g., an always-on processor (AOP), a UWB chip, and/or an application processor. For example, parts of ranging module 828 can determine a distance on an AOP, and another part of the ranging module can interact with a sharing module, e.g., to display a position of the other device on a screen in order for a user to select the other device to share a data item. Ranging module 828 can also interact with a reminder module that can provide an alert based on a distance from another mobile device.

The one or more applications 834 on device 800 can include any applications installed on the device 800, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 806 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 806 can include a display and user input devices such as a keyboard, mouse, and/or trackpad. In some embodiments, I/O subsystem 806 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 802) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 806 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 800 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

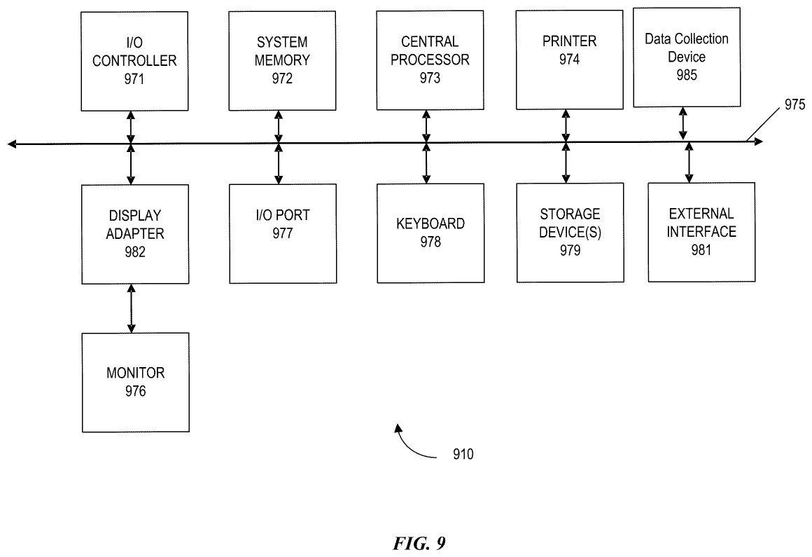

Any of the computer systems mentioned herein may utilize any suitable number of subsystems. Examples of such subsystems are shown in FIG. 9 in computer system 910. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 9 are interconnected via a system bus 975. Additional subsystems such as a printer 974, keyboard 978, storage device(s) 979, monitor 976 (e.g., a display screen, such as an LED), which is coupled to display adapter 982, and others are shown. Peripherals and input/output (I/O) devices, which couple to I/O controller 971, can be connected to the computer system by any number of means known in the art such as input/output (I/O) port 977 (e.g., USB, FireWire®). For example, I/O port 977 or external interface 981 (e.g. Ethernet, Wi-Fi, etc.) can be used to connect computer system 910 to a wide area network such as the Internet, a mouse input device, or a scanner. The interconnection via system bus 975 allows the central processor 973 to communicate with each subsystem and to control the execution of a plurality of instructions from system memory 972 or the storage device(s) 979 (e.g., a fixed disk, such as a hard drive, or optical disk), as well as the exchange of information between subsystems. The system memory 972 and/or the storage device(s) 979 may embody a computer readable medium. Another subsystem is a data collection device 985, such as a camera, microphone, accelerometer, and the like. Any of the data mentioned herein can be output from one component to another component and can be output to the user.

A computer system can include a plurality of the same components or subsystems, e.g., connected together by external interface 981, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method comprising:
detecting, by a first electronic device, one or more identifiers of one or more electronic devices that are associated with the first electronic device;
accessing, by the first electronic device, a set of device properties corresponding to a set of electronic devices that includes the one or more electronic devices;
accessing, by the first electronic device, a subset of device properties of the set of device properties, where the subset of device properties correspond to the one or more electronic devices;
comparing, by the first electronic device, the subset of device properties against one or more group criteria, wherein a device property comprises at least one of a device type, a software version, a power capacity, a charging state, a signal strength, and an activity state;
designating, by the first electronic device, the first electronic device as a group leader device of the one or more electronic devices based at least in part on the comparing; and
performing, by the first electronic device, a scheduled operation.

2. The method of claim 1, wherein accessing the subset of device properties comprises:
generating, by the first electronic device, a set of generated keys by providing the one or more identifiers as input to a key algorithm;
comparing, by the first electronic device, the set of generated keys to a stored set of keys to identify a subset of keys that correspond a subset of electronic devices that are associated with the first electronic device, where the subset of keys are present in both the set of generated keys and the stored set of keys; and
accessing, by the first electronic device, the subset of device properties using the subset of keys.

3. The method of claim 1, wherein the one or more identifiers are detected by:
receiving, by the first electronic device, a plurality of advertising messages from a plurality of electronic devices, wherein the plurality of advertising messages are transmitted using a short-range communication protocol; and
identifying, by the first electronic device, the one or more identifiers from the plurality of advertising messages.

4. The method of claim 3, wherein the short-range communication protocol is one of a Bluetooth communication protocol, a Bluetooth low energy communication protocol, or a WiFi communication protocol.

5. The method of claim 1, wherein the first electronic device and the one or more electronic devices are at a location.

6. The method of claim 1, wherein the first electronic device is at a first location and the one or more electronic devices are at a second location.

7. The method of claim 6, wherein detecting the one or more identifiers of the one or more electronic devices comprises:
receiving, by the first electronic device and at the first location, at least one of the one or more identifiers from an electronic device at the second location via a network connection.

8. The method of claim 1, wherein the signal strength is a received signal strength indicator (RSSI).

9. The method of claim 1, wherein the activity state of a corresponding electronic device includes a number of location changes for the corresponding electronic device, a number of separate access point connection events for the corresponding electronic device, a number of processor wake events for the corresponding electronic device, and a screen wake duration for the corresponding electronic device, and a predicted wake time for the corresponding electronic device.

10. A computing device, comprising:
one or more memories; and
one or more processors in communication with the one or more memories and configured to execute instructions stored in the one or more memories to perform operations comprising:
detecting one or more identifiers of one or more electronic devices that are associated with the computing device;
accessing a set of device properties corresponding to a set of electronic devices that includes the one or more electronic devices;
accessing a subset of device properties of the set of device properties, where the subset of device properties correspond to the one or more electronic devices;
comparing the subset of device properties against one or more group criteria, wherein a device property comprises at least one of a device type, a software version, a power capacity, a charging state, a signal strength, or an activity state;
designating the computing device as a group leader device of the one or more electronic devices based at least in part on the comparing; and
performing a scheduled operation.

11. The computing device of claim 10, wherein accessing the subset of device properties comprises:
generating a set of generated keys by providing the one or more identifiers as input to a key algorithm;
comparing the set of generated keys to a stored set of keys to identify a subset of keys that correspond a subset of electronic devices that are associated with the computing device, where the subset of keys are present in both the set of generated keys and the stored set of keys; and
accessing the subset of device properties using the subset of keys.

12. The computing device of claim 10, wherein the one or more identifiers are detected by:
receiving a plurality of advertising messages from a plurality of electronic devices, wherein the plurality of advertising messages are transmitted using a short-range communication protocol; and
identifying the one or more identifiers from the plurality of advertising messages.

13. The computing device of claim 10, wherein the computing device and the one or more electronic devices are at a location.

14. The computing device of claim 10, wherein the computing device is at a first location and the one or more electronic devices are at a second location.

15. The computing device of claim 10, wherein the signal strength is a received signal strength indicator (RSSI).

16. The computing device of claim 10, wherein the activity state of a corresponding electronic device includes a number of location changes for the corresponding electronic device, a number of separate access point connection events for the corresponding electronic device, a number of processor wake events for the corresponding electronic device, and a screen wake duration for the corresponding electronic device, and a predicted wake time for the corresponding electronic device.

17. A non-transitory computer-readable medium storing a plurality of instructions that, when executed by one or more processors of a computing device, cause the one or more processors to perform operations comprising:
detecting one or more identifiers of one or more electronic devices that are associated with the computing device;
accessing a set of device properties corresponding to a set of electronic devices that includes the one or more electronic devices;
accessing a subset of device properties of the set of device properties, where the subset of device properties correspond to the one or more electronic devices;
comparing the subset of device properties against one or more group criteria, wherein a device property comprises at least one of a device type, a software version, a power capacity, a charging state, a signal strength, or an activity state;
designating the computing device as a group leader device of the one or more electronic devices based at least in part on the comparing; and
performing a scheduled operation.

18. The non-transitory computer-readable medium of claim 17, wherein accessing the subset of device properties comprises:
generating a set of generated keys by providing the one or more identifiers as input to a key algorithm;
comparing the set of generated keys to a stored set of keys to identify a subset of keys that correspond a subset of electronic devices that are associated with the computing device, where the subset of keys are present in both the set of generated keys and the stored set of keys; and
accessing the subset of device properties using the subset of keys.

19. The non-transitory computer-readable medium of claim 17, wherein the one or more identifiers are detected by:
receiving a plurality of advertising messages from a plurality of electronic devices, wherein the plurality of advertising messages are transmitted using a short-range communication protocol; and
identifying the one or more identifiers from the plurality of advertising messages.

20. The non-transitory computer-readable medium of claim 17, wherein the computing device and the one or more electronic devices are at a location.
